(19) United States
(12) Patent Application Publication
(10) Pub. No.: US 2024/0015295 A1
(43) Pub. Date: Jan. 11, 2024

(54) INTRA-PREDICTION FUSION FOR VIDEO CODING

(71) Applicant: QUALCOMM Incorporated, San Diego, CA (US)

(72) Inventors: Keming Cao, San Diego, CA (US); Bappaditya Ray, San Diego, CA (US); Yao-Jen Chang, San Diego, CA (US); Vadim Seregin, San Diego, CA (US); Marta Karczewicz, San Diego, CA (US)

(21) Appl. No.: 18/339,302

(22) Filed: Jun. 22, 2023

Related U.S. Application Data
(60) Provisional application No. 63/367,804, filed on Jul. 6, 2022.
(60) Provisional application No. 63/368,221, filed on Jul. 12, 2022.

(51) Int. Cl. H04N 19/132; H04N 19/105; H04N 19/159; H04N 19/176

(52) U.S. Cl. CPC H04N 19/132; H04N 19/105; H04N 19/159; H04N 19/176

(57) ABSTRACT

A method of decoding video data includes generating a fusion of predictors from two or more reference lines of samples relative to a block of video data based on an intra-prediction mode. The method further includes decoding the block of video data using the fusion of predictors and the intra-prediction mode.

This application claims the benefit of U.S. Provisional Patent Application No. 63/367,804, filed Jul. 6, 2022, and U.S. Provisional Patent Application No. 63/368,221, filed Jul. 12, 2022, the entire content of each of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for decoding video data. In particular, this disclosure describes techniques for decoding blocks of video data using a fusion of predictors from two or more reference lines of samples based on an intra-prediction mode. For example, a video coder may combine (e.g., fuse) reference samples from two or more lines of reference samples to form a new fusion of predictors that may be used to code video data according to an intra-prediction mode. By fusing the predictors from two or more reference lines, the system may generate more accurate predictions. As a result, the techniques may reduce computational resources, which may be particularly important for resource-constrained devices, such as smartphones, tablets, embedded systems, etc. Additionally, the techniques may reduce the time required to decode and display video content, which may lower latency (e.g., the delay between capturing a video frame and displaying the video frame), improve streaming performance, etc. Thus, the techniques may improve coding efficiency and performance of intra-prediction in video codecs.

In one example, a method includes generating a fusion of predictors from two or more reference lines of samples relative to a block of video data based on an intra-prediction mode, and decoding the block of video data using the fusion of predictors and the intra-prediction mode.

In another example, a device includes a memory and one or more processors in communication with the memory, the one or more processors configured to generate a fusion of predictors from two or more reference lines of samples relative to a block of video data based on an intra-prediction mode, and decode the block of video data using the fusion of predictors and the intra-prediction mode.

In another example, a device includes means for generating a fusion of predictors from two or more reference lines of samples relative to a block of video data based on an intra-prediction mode, and means for decoding the block of video data using the fusion of predictors and the intra-prediction mode.

In another example, a computer-readable storage medium is encoded with instructions that, when executed, cause a programmable processor to generate a fusion of predictors from two or more reference lines of samples relative to a block of video data based on an intra-prediction mode, and decode the block of video data using the fusion of predictors and the intra-prediction mode.

In another example, a method includes generating a fusion of predictors from two or more reference lines of samples relative to a block of video data based on an intra-prediction mode, and encoding the block of video data using the fusion of predictors and the intra-prediction mode.

In another example, a device includes a memory and one or more processors in communication with the memory, the one or more processors configured to generate a fusion of predictors from two or more reference lines of samples relative to a block of video data based on an intra-prediction mode, and encode the block of video data using the fusion of predictors and the intra-prediction mode.

In another example, a device includes means for generating a fusion of predictors from two or more reference lines of samples relative to a block of video data based on an intra-prediction mode, and means for encoding the block of video data using the fusion of predictors and the intra-prediction mode.

In another example, a computer-readable storage medium is encoded with instructions that, when executed, cause a programmable processor to generate a fusion of predictors from two or more reference lines of samples relative to a block of video data based on an intra-prediction mode, and encode the block of video data using the fusion of predictors and the intra-prediction mode.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example reference line used for intra-prediction.

FIG. 3 is a conceptual diagram illustrating an example of multiple reference lines used for intra-prediction.

FIG. 4 is a conceptual diagram illustrating an example template and reference samples used in template-based intra mode derivation (TIMD).

FIG. 5 is a conceptual diagram illustrating example angular intra-prediction modes in one version of the enhanced compression model (ECM).

FIG. 6 is a conceptual diagram illustrating an example of integer slopes and non-integer slopes for angular intra-prediction modes.

FIG. 7 is a block diagram illustrating an example video encoder that may perform the techniques of this disclosure.

FIG. 8 is a block diagram illustrating an example video decoder that may perform the techniques of this disclosure.

FIG. 9 is a flowchart illustrating an example method for encoding a current block in accordance with the techniques of this disclosure.

FIG. 10 is a flowchart illustrating an example method for decoding a current block in accordance with the techniques of this disclosure.

FIG. 11 is a flowchart illustrating an example method for encoding a current block in accordance with the techniques of this disclosure.

FIG. 12 is a flowchart illustrating an example method for decoding a current block in accordance with the techniques of this disclosure.

### DETAILED DESCRIPTION

In general, video coding techniques may use intra-prediction to reduce the amount of data needed to represent video content while maintaining high visual quality. Example intra-prediction modes may include a DC mode, a planar mode, and directional modes (e.g., angular modes). The choice of intra-prediction mode for a specific block may depend on the content within the block and the neighboring blocks. While intra-prediction offers several advantages in video compression, it also has some disadvantages. For example, intra-prediction may sometimes result in relatively large residual data (e.g., the difference between predicted and actual blocks). Encoding large residual data can lead to lower compression efficiency.

This disclosure describes techniques that may improve the coding efficiency of intra-prediction. In particular, this disclosure describes techniques where intra-prediction is performed by using two or more lines of reference sample to form fused reference predictors. That is, a video coder may combine (e.g., fuse) reference samples from two or more lines of reference samples to form a new fusion of predictors that may be used to code video data according to an intra-prediction mode. By fusing the predictors from two or more reference lines, the system may generate more accurate predictions which may not only lead to smaller residual data that can be compressed more efficiently, but also improve visual quality (e.g., because a more accurate block prediction algorithm decreases the errors and artifacts introduced during the compression and decompression process). Additionally, the techniques may lead to faster decoding times and lower computational resource requirements, which may be particularly important for resource-constrained devices and applications like streaming.

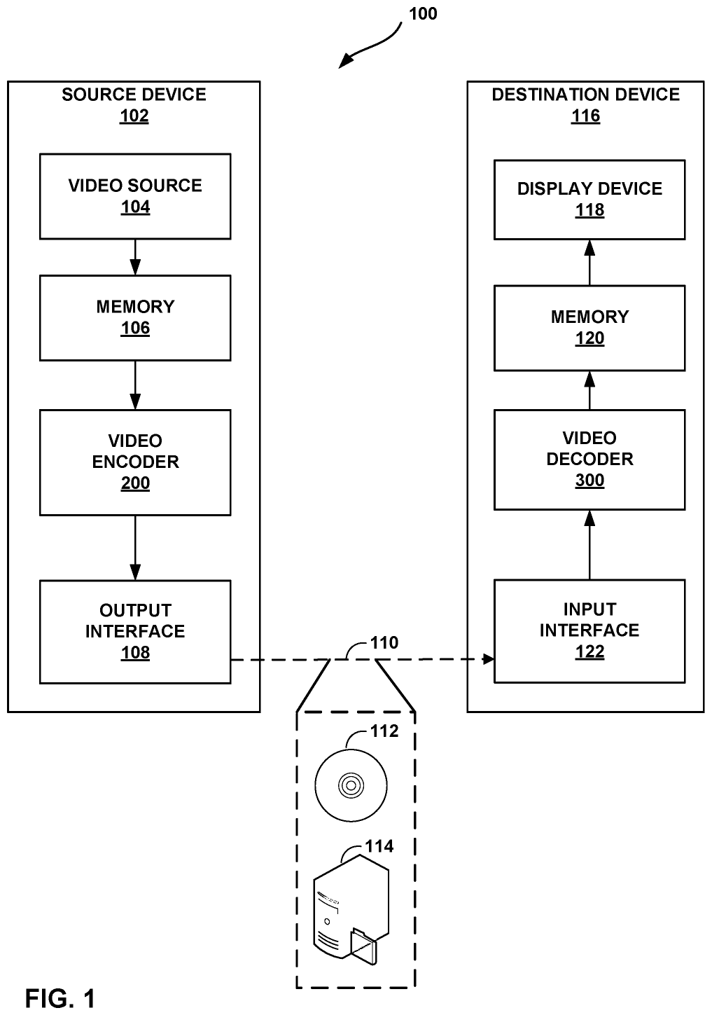

FIG. 1 is a block diagram illustrating an example video encoding and decoding system 100 that may perform the techniques of this disclosure. The techniques of this disclosure are generally directed to coding (i.e., encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for intra-prediction fusion. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for intra-prediction fusion. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use intra-prediction.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra-prediction (e.g., intra frame prediction or spatial prediction) and inter prediction (e.g., inter frame prediction or temporal prediction). In the context of AV1, when predicting blocks of a current frame of video data using an intra-prediction mode, video encoder 200 and video decoder 300 do not use video data from other frames of video data. For most intra-prediction modes, video encoder 200 encodes blocks of a current frame based on the difference between sample values in the current block and predicted values generated from reference samples in the same frame. Video encoder 200 determines predicted values generated from the reference samples based on the intra-prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block. This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, as will be explained in more detail below, video encoder 200 and video decoder 300 may be configured to generate a fusion of predictors from two or more reference lines of samples relative to a block of video data based on an intra-prediction mode, and encode/decode the block of video data using the fusion of predictors and the intra-prediction mode.

Intra-prediction

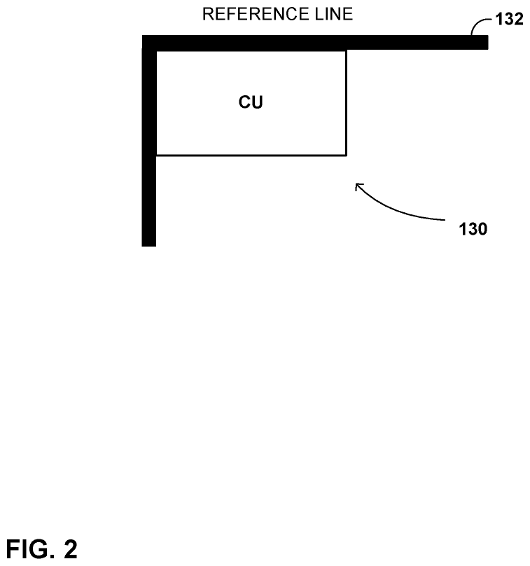

Intra-prediction is a fundamental component in many video codecs. For a current coding unit 130 (“CU 130”), the prediction of samples inside CU 130 may be generated from a reference line 132 according to different intra-prediction modes, such as Planar mode, DC mode, and one of a plurality of Angular modes (also called directional modes). In one example, the default reference line of samples is the line of samples that is the closest to CU 130, as shown in FIG. 2. For an angular mode, based on mode direction, a video coder may determine whether interpolation of reference samples with a 6-tap/4-tap filter, smoothing with a Gaussian filter, or directly copying reference sample values is performed.

Multiple Reference Line (MRL)

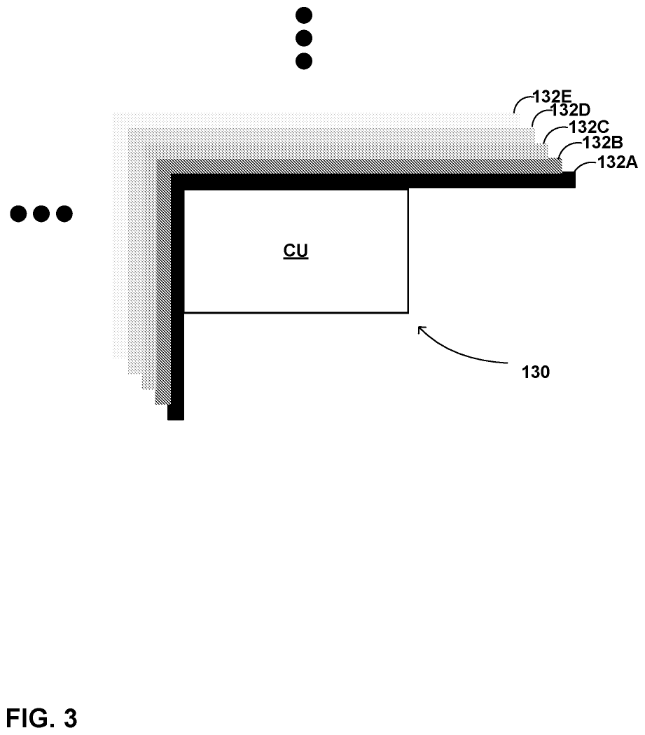

As shown in FIG. 3, the default reference line of samples may be a line 132A (e.g., a “line 0”) that is directly adjacent above and directly adjacent to the left of the current coding unit. In MRL mode, a video coder may be configured to use other reference lines, such as lines 132B-N(generally referred to as “lines 132, which may correspond to a second line, a third line, a fourth line, etc.). FIG. 3 only illustrates lines 132A-132E for ease of illustration. This MRL mode is called multiple reference line (MRL) in the Enhanced Compression Model (ECM) being developed by JVET.

Decoder-Side Intra Mode Derivation (DIMD)

In addition to planar mode, DC mode and angular mode, another intra-prediction mode is decoder-side intra mode derivation (DIMD), in which video decoder 300 is configured to derive the intra coding mode from the decoder side. In some examples, video decoder 300 may be configured to derive the intra coding mode using a Histogram of Gradients (HoG). For example, an HoG may be or otherwise represent a vector of length 67 with each element denoting the magnitude of corresponding direction. The HoG may create a cue for a possible angular mode. For a current coding unit (CU), video decoder 300 may compute the HoG with reconstructed samples from the above reconstructed neighbor, the left reconstructed neighbor, and the top-left corner neighbor.

In some examples, video decoder 300 may implement DIMD by fusing the predictors from multiple intra-prediction modes. For example, video decoder 300 may fuse the predictors from the two angular modes with the highest magnitudes (e.g., based on the HoG) with a planar mode to determine a final prediction from DIMD. The two angular modes may be mode1 and mode2, and the magnitude of mode1 and mode2 may be mag1 and mag2, respectively. In some examples, video decoder 300 may determine the weights of fusion for mode1, mode2 and planar mode, respectively, to be 2mag1/3(mag1+mag2), 2mag2/3(mag1+mag2) and ⅓.

Template-based Intra Mode Derivation (TIMD)

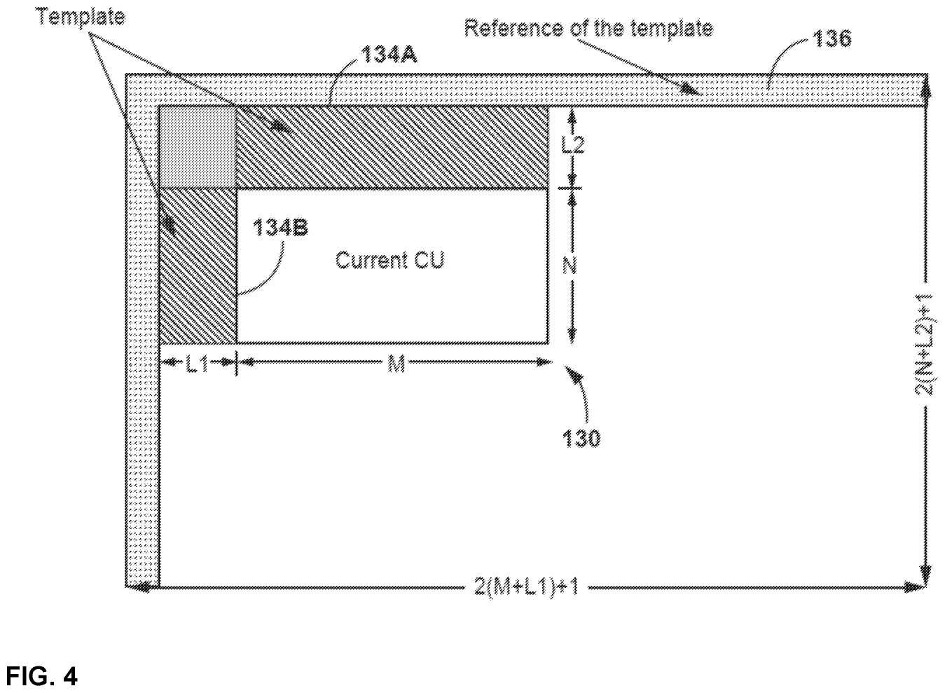

Another decoder-side intra mode derivation method is template-based intra mode derivation. FIG. 4 is a conceptual diagram illustrating example template and reference samples used in template-based intra mode derivation. Given CU 130, video decoder 300 may choose two template regions 134A-134B (e.g., above the CU 130 and to the left of the CU 130) and a corresponding reference template 136. For each mode in the most probable mode (MPM) list, video decoder 300 may generate a prediction for template region 136 and compute a sum of absolute transformed differences (SATD) cost on template region 136 between the prediction and the reconstruction samples. Video decoder 300 may choose the mode with the lowest cost as the mode for TIMD.

Video decoder 300 may determine a mode1 and mode2 with the least SATD cost. The cost of mode1 and mode2 may be cost1 and cost2, respectively. In some examples, responsive to determining that 2*cost1<cost2, video decoder 300 may fuse mode1 and mode2 and determine the weights of fusion for mode1 and mode2 to be

$$\frac{cost 2}{cost 1 + cost 2} and \frac{cost 1}{cost 1 + cost 2} ,$$

respectively. Otherwise, video decoder 300 may use mode1 without fusion.

Angular Mode with Integer Slope/Non-Integer Slope

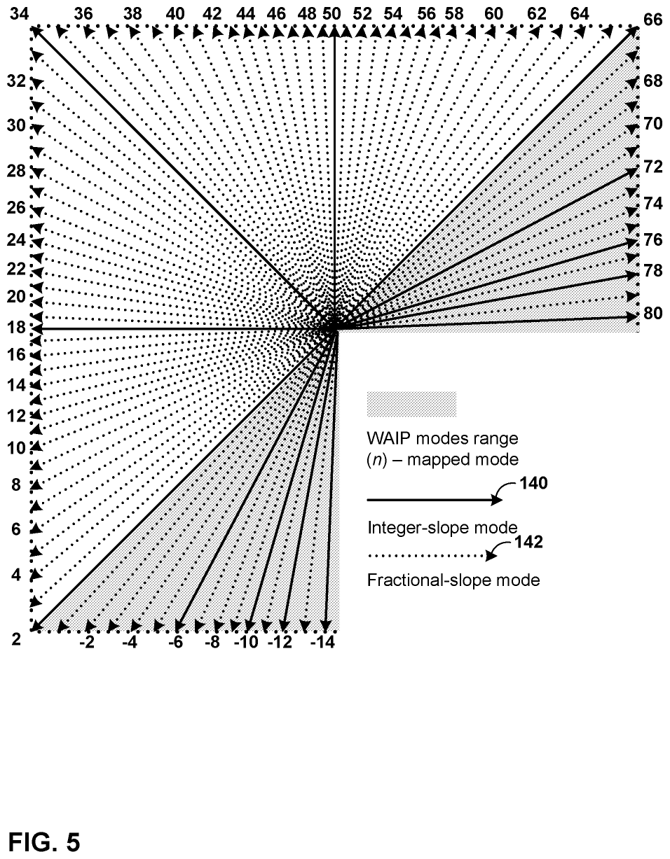

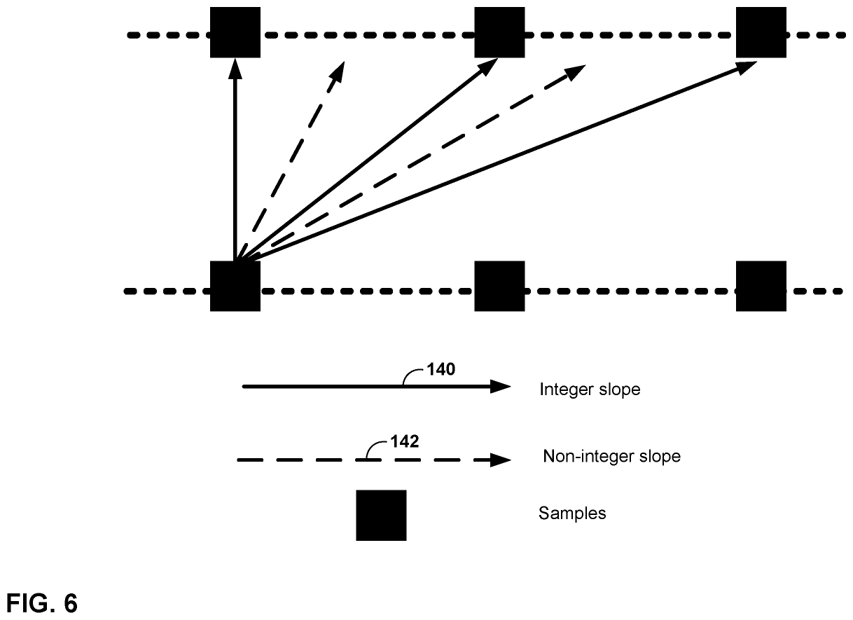

FIG. 5 is a conceptual diagram illustrating example angular intra-prediction modes in one version of ECM. In FIG. 5, the various arrows correspond to different angular modes indicating different directions in ECM. For different directions, some directions fall between reference samples and some directions fall on reference samples, as shown in FIG. 6. FIG. 6 is a conceptual diagram illustrating an example of integer slopes and non-integer slopes for angular intra-prediction modes. In FIG. 6, the directions that fall on reference samples have integer slopes and those directions falling in between have non-integer slopes. In FIGS. 5 and 6, solid arrows 140 correspond to directions having integer slopes, and dashed arrows 142 correspond to directions having non-integer slopes.

Most Probable Modes (MPM) List

In some examples of intra-prediction, video encoder 200 and video decoder 300 may generate a list of most probable modes (e.g., an MPM list) for each prediction unit (PU). When encoding the prediction mode, instead of directly writing the mode into the bitstream, video encoder 200 may encode an index into the MPM list of the actual chosen mode. Video decoder 300 may then use the index as an input to the MPM list generated at the video decoder to determine the intra-prediction mode.

In ECM, the MPM list is of length 22 and may include two parts. The first 6 modes in MPM list may be called the primary MPM list. They may include planar mode, a mode from the left PU, a mode from the above PU, a mode from the below-left PU, a mode from the above-right PU, and a mode from the above-left PU. The next 16 modes in MPM list may be called the secondary MPM list, which may include modes derived by offsets from the modes in the primary MPM list. Video encoder 200 and video decoder 300 may add the DIMD modes (e.g., mode1 and mode2) after the primary MPM list and before the secondary MPM list in the final MPM list.

Video encoder 200 and video decoder 300 may add all modes that are not included in the MPM list to a non-MPM list. Video encoder 200 and video decoder 300 may also generate a separate MPM list for the chroma channels, where the first 4 modes of the chroma MPM list correspond to the modes in the luma MPM list.

In an example of the ECM software, intra-prediction only uses one reference line for CU sample prediction. Even when the MRL mode is enabled, video decoder 300 may only use one reference line, which may decrease the prediction accuracy in some circumstances.

Several methods are described in this disclosure addressing the aforementioned problems. The techniques of this disclosure can be used individually or in any combination. In accordance with techniques of this disclosure, video decoder 300 may decode video data by generating a fusion of predictors from two or more reference lines of samples relative to a block of video data based on an intra-prediction mode. By fusing the predictors from two or more reference lines, the system may generate more accurate predictions which may not only lead to smaller residual data that can be compressed more efficiently, but also improve visual quality. Additionally, the techniques may lead to faster decoding times and lower computational resource requirements.

Video encoder 200 and video decoder 300 may generate a fusion of predictors from two or more reference lines of samples relative to a block of video data based on an intra-prediction mode. In some examples, video encoder 200 and video decoder 300 may generate the fusion of predictors based on a weighted combination of the predictors from the two or more reference lines of samples based on the intra-prediction mode. For example, video encoder 200 and video decoder 300 may select the reference lines for the predictors as combinations of a regular default reference line (e.g., line 132A of FIG. 3) and other, different reference lines (e.g., one or more of lines 132B-132N of FIG. 3). The other reference lines can be a single reference line or more than one reference lines.

In another example, video encoder 200 and video decoder 300 may select the reference lines for the predictors as combinations of any two intra predictors, for example derived from any two reference lines. Those lines may be different. In some examples, video encoder 200 and video decoder 300 may generate the fusion of predictors based on a weighted combination of the predictors from two or more intra modes derived from the same reference line, but using different intra-prediction methods.

Video encoder 200 and video decoder 300 may be configured to generate a fusion of predictors from two or more reference lines of samples relative to a block of video data, and code (e.g., encode or decode) the block of video data using the fusion of predictors and the intra-prediction mode. In one example, the two or more reference lines of samples includes a default reference line of samples, such as one of lines 132 of FIG. 3 (e.g., line 132A, which is immediately adjacent to CU 130). In another example, the default reference line of samples is immediately adjacent the block of video data (e.g., lines 132A-132B of FIG. 3, which may correspond to a line0 and a line1). In general, the two or more reference lines may include any of lines 132.

Video encoder 200 and video decoder 300 may be configured to determine the predictors from the two or more reference lines of samples using the same intra-prediction mode. In another example, video encoder 200 and video decoder 300 may be configured to determine the predictors from the two or more reference lines of samples using at least two different intra-prediction modes. In some examples, the at least two different intra prediction modes may be angular modes. In any case, video encoder 200 and video decoder 300 apply the intra-prediction fusion to an intra-prediction mode that has a non-integer slope.

In one example, video encoder 200 and video decoder 300 may be configured to choose the reference lines as subsets of the lines used in MRL prediction. In other words, the reference lines of samples may be a subset of a set of reference lines of samples for a MRL coding mode. In one example, the subset of the set of reference lines of samples includes a default reference line of samples adjacent the block of video data, and another reference line of samples adjacent the default reference line of samples. For example, video encoder 200 and video decoder 300 may use line0 as the default reference line and line 1 as the other reference line. Thus, if MRL mode applies to a set of default reference lines {1, 3, 5, 7, 12}, then when using fusion in conjunction with MRL the set of lines may include {[1,2], [3,4], [5,6], [7, 8], [12,13]}). In another example, video encoder 200 and video decoder 300 may use a non-adjacent line as the other reference line (e.g., such as line3 and line5, if line 1 is the default reference line).

In another example, video encoder 200 and video decoder 300 may choose the other reference lines as the reference lines that have certain distance to the regular default reference line. For example, the other reference line may be the adjacent reference line, which is line1. In another example, video encoder 200 and video decoder 300 may choose the other reference lines specifically as lines not used in MRL prediction to provide diversity. For example, the other reference lines may be line2 and line4, which are not used in the current MRL mode. In another example, the other reference lines may also be a mix of reference lines that are used and not used in MRL.

Several selection techniques are described above. However, video encoder 200 and video decoder 300 may use other techniques to identify the other reference lines used for the fusion mode, and such techniques should be considered to be in the scope of this disclosure.

In one example, video encoder 200 and video decoder 300 may achieve a fusion of two or more intra predictors by determining a weighted combination of the predictors from multiple reference lines. For example, video encoder 200 and video decoder 300 may calculate the fusion of the predictors using the equation p_{fusion}=Σᵢ₌₀^{N}wᵢpᵢ, where p_{fusion} represents the fused reference intra-prediction value, wᵢ represents the weight of the predictor having index position i, and pᵢ represents the intra-prediction value for the predictor having index position i. For example, video encoder 200 and video decoder 300 may apply a first weight to predictors in a default reference line, and apply a second weight to predictors in the other reference line. The default reference line may be closer to the block of video data than the other reference line. In any case, video encoder 200 and video decoder 300 may select the reference lines using any method described herein.

In one example, the weights for each predictors may be fixed. For example, video encoder 200 and video decoder 300 may apply fusion on intra-prediction values derived from one reference, denoted as p₀, and intra-prediction values derived from other reference line, denoted as p₁. Video encoder 200 and video decoder 300 may calculate the fusion of the predictors using the equation p_{fusion}=w₀p₀+w₁p₁. In one example, video encoder 200 and video decoder 300 may determine that the fixed weights are w₀=¾ and w₁=¼. In other words, video encoder 200 and video decoder 300 may determine that the first weight is 0.75 and the second weight is 0.25.

In another example, video encoder 200 and video decoder 300 may determine the weights (e.g., the first weight, the second weight, etc.) based on the position of a current sample in the block and one or more of a width or a height of the block. A current sample position may be (x, y) and a current coding unit size may be (w, h). For example, video encoder 200 and video decoder 300 may determine the position dependent weights using the equations w₀=y/h and w₁=1−y/h. In another example, video encoder 200 and video decoder 300 may determine the position dependent weights using the equations w₀=1−x/w and w₁=x/w.

In another example, video encoder 200 and video decoder 300 may determine the weights based on certain criteria, such as satisfaction of a threshold. For example, responsive to the absolute value of first predictors minus second predictors (e.g., |p₀−p₁|) satisfying a threshold (e.g., being greater than or equal to the threshold), video encoder 200 and video decoder 300 may determine that the first weight is 0.75 and the second weight is 0.25. responsive to the absolute value of first predictors minus second predictors not satisfying the threshold, video encoder 200 and video decoder 300 may determine that the first weight is 0.5 and the second weight is 0.5.

In another example, video encoder 200 and video decoder 300 may determine the weights based on the cost of the templates used in intra-prediction, for example, SATD, which is used in TIMD. In one example, SATD cost for the first intra predictor is cost1, and cost2 is the SATD cost for the second intra predictor. Video encoder 200 and video decoder 300 may determine the weights using the equations

$${w}_{0} = \frac{cost 2}{cost 1 + cost 2} and {w}_{1} = \frac{cost 1}{cost 1 + cost 2} ,$$

where w₀+w₁=1.

In one example, video encoder 200 and video decoder 300 may achieve fusion by adding weighted gradient between the predictors. In one example, video encoder 200 and video decoder 300 may achieve fusion by using the equation p_{fusion}=p₀+Σᵢ₌₁^{N}wᵢ(pᵢ−p₀), where p_{fusion} represents the fused reference intra-prediction value, wᵢ represents the weight of the predictor having index position i, pᵢ represents the intra-prediction value for the predictor having index position i, and p₀ represents the intra-prediction value for the predictor from the first or default reference. As described above, the weights can be fixed, depend on pixel/sample position, depend on certain criteria or cost from the templates, etc.

In one example, video encoder 200 and video decoder 300 may apply intra-prediction fusion implicitly. For example, video encoder 200 and video decoder 300 may apply intra-prediction fusion regardless of the intra modes involved or size of the CU. In another example, video encoder 200 and video decoder 300 may apply intra-prediction fusion explicitly. Video encoder 200 may encode and signal a flag on the CU level or slice level in the bitstream to indicate whether to apply intra-prediction fusion.

In one example, whether video encoder 200 and video decoder 300 applies intra-prediction fusion may depend on the intra mode. In one example, video encoder 200 and video decoder 300 may apply intra-prediction fusion for any intra mode, such as Planar mode, DC mode, and angular mode. In another example, video encoder 200 and video decoder 300 may apply intra-prediction fusion only for a subset of intra modes (e.g., only for angular modes). In another example, video encoder 200 and video decoder 300 may only apply intra-prediction fusion for the modes that have non-integer slopes (e.g., as shown in FIGS. 5-6). Examples of intra-prediction modes that have non-integer slopes may include dashed lines 142 shown in FIG. 5.

Video encoder 200 and video decoder 300 may use other conditions to identify the intra mode subset used or whether to apply fusion, and those conditions shall also considered to be within the scope of this disclosure. Video encoder 200 and video decoder 300 may use the explicit condition to check whether to apply the disclosed fusion mode and to which intra modes. If all modes satisfy the condition, then video encoder 200 and video decoder 300 may apply the disclosed fusion method to all intra modes; otherwise, video encoder 200 and video decoder 300 may not apply fusion. In another example, video encoder 200 and video decoder 300 may apply the disclosed fusion method if any of the involved modes satisfies the condition, and other modes may or may not follow the condition. The difference between the two examples is that in the first case mode0 and mode1 both have to satisfy the condition, while in the second example only mode0 or mode1 needs to satisfy the condition, but the other mode may or may not.

Video encoder 200 and video decoder 300 may apply one or more interpolation filters to the block of video data. Video encoder 200 and video decoder 300 may derive the prediction samples from the reference sample after interpolation with any types of filters, for example, 6-tap filter or 4-tap filter. In some examples, video encoder 200 and video decoder 300 may derive the prediction samples from a mix of different types of filters. For example, video encoder 200 and video decoder 300 may derive one prediction sample from 6-tap interpolation filter and another prediction sample from 4-tap interpolation filter.

In one example, whether video encoder 200 and video decoder 300 applies intra prediction fusion depends on block size. In one example, video encoder 200 and video decoder 300 may apply intra-prediction fusion when CU area is greater than N, where, for example, N is equal 32.

In another example, intra-prediction fusion may depend on the prediction mode used to code a current block. For example, when the current intra mode is DIMD mode or TIMD mode, video encoder 200 and video decoder 300 may disable intra-prediction fusion. For another example, when CU 130 is coded in intra sub partition (ISP) mode, video encoder 200 and video decoder 300 may disable intra-prediction fusion. In other words, video encoder 200 and video decoder 300 may use intra-prediction fusion (e.g., generate a fusion of predictors from multiple reference lines of samples) when ISP mode is disabled.

In another example, video encoder 200 and video decoder 300 may combine intra-prediction fusion with other prediction modes that use other types of fusion, for example TIMD/DIMD. Since those modes (TIMD or DIMD) may already utilize other fusion, video encoder 200 and video decoder 300 may apply fusion in a one or two stage process. In a two-stage fusion case, video encoder 200 and video decoder 300 may apply intra-prediction fusion in accordance with the techniques first for each mode from TIMD and DIMD. Video encoder 200 and video decoder 300 may then apply the fusion specific to those modes in the second stage. In that case, video encoder 200 and video decoder 300 may separate the weights for intra-prediction fusion and TIMD/DIMD mode fusion. Video encoder 200 and video decoder 300 may determine that the weights for intra-prediction are ¾ and ¼ and determine the fusion weights for TIMD/DIMD mode independently.

In a one-stage fusion example, for each TIMD/DIMD mode, video encoder 200 and video decoder 300 may derive two or more predictors from different reference lines. Video encoder 200 and video decoder 300 may fuse those predictors together to avoid rounding error resulting from the fusion. For example, if TIMD/DIMD use intra mode0 and intra mode1 in the prediction, then video encoder 200 and video decoder 300 may derive two predictors using different reference lines from intra mode0, which may be denoted as intra mode 00 and mode 01. Similarly, video encoder 200 and video decoder 300 may derive two predictors using different reference lines from intra mode 1, which may be denoted as intra mode 10 and mode 11. In a one-stage fusion, video encoder 200 and video decoder 300 may fuse these 4 modes (mode 00, mode 01, mode 10, mode 11) together with certain weights. Video encoder 200 and video decoder 300 may apply the same or substantially similar technique for more than two predictors derived using more than two reference lines.

In a two-stage process, video encoder 200 and video decoder 300 may derive mode 0 from mode 00 and mode 01 by using the described method. Similarly, video encoder 200 and video decoder 300 may derive mode 1 from the mode 10 and mode 11, which represents the first-stage. Then video encoder 200 and video decoder 300 may fuse modes 0 and 1 according to the fusion method specific for TIMD/DIMD as the second-stage.

Video encoder 200 and video decoder 300 may derive the weights in a one stage process by multiplying the fixed weights w₀ and w₁ of the disclosed method with the weights used in TIMD and DIMD. In another alternative, video encoder 200 and video decoder 300 may derive the weights for the involved modes according to the template cost.

In examples where intra-prediction fusion is enabled with TIMD/DIMD, video encoder 200 and video decoder 300 may apply the position dependent intra-prediction combination (PDPC) processing for each of the predictors only once at the end of the modes fusion. In another example, video encoder 200 and video decoder 300 may apply PDPC processing immediately after each predictor.

In one example, video encoder 200 and video decoder 300 may apply intra-prediction fusion combined with other tools, such as MRL, ISP, and matrix-based intra-prediction (MIP). When intra-prediction fusion is enabled with MRL, video encoder 200 and video decoder 300 may use the default reference line to derive MRL prediction (typically signaled as MRL index in bitstream), and video encoder 200 and video decoder 300 may choose the other reference lines from the lines which can be used in MRL prediction. For example, if video encoder 200 and video decoder 300 uses line3 as the current reference line, video encoder 200 and video decoder 300 may choose line5 as the other reference line. In another example, if video encoder 200 and video decoder 300 uses line3 as the current reference line, video encoder 200 and video decoder 300 may choose line1 as the other reference line. In yet another example, if video encoder 200 and video decoder 300 uses line3 is the current reference line, video encoder 200 and video decoder 300 may choose line5 and line7 as the other reference lines.

In another example, video encoder 200 and video decoder 300 may apply the intra-prediction fusion techniques of this disclosure on a subset of MRL candidate lists. For example, video encoder 200 and video decoder 300 may apply intra-prediction fusion to the first three candidates in an MRL candidate list.

In some examples, video encoder 200 and video decoder 300 may apply intra-prediction fusion with mode signaling. In one example, video encoder 200 and video decoder 300 may construct a candidate list first to include all modes, such as DC, planar, angular modes, TIMD and DIMD modes. The modes in the list can be from an MPM list, from a preset list of intra modes, for example, {Planar mode, DC mode, Horizontal, Vertical}, or from the mode list after video encoder 200 and video decoder 300 runs the first round of SATD check.

The intra mode list can be composed of intra directions and other intra-prediction methods as a combination. For example, an entry of the intra mode list may be composed as {intra direction, MRL index, whether fusion is applied} and similar combinations. Instead of signaling an intra direction, MRL index, and fusion flag, video encoder 200 and video decoder 300 may transmit an index to the intra mode list.

Two entries may be different if, for example, at least one component of the combination is different. For example, {intra direction 10, MRL index 3, no fusion} is different from {intra direction 10, MRL index 1, no fusion}, and is also different for {intra direction 10, MRL index 1, fusion applied}.

The length of the list can be fixed or adaptively defined. For example, video encoder 200 and video decoder 300 may use reconstructed neighbor samples and intra modes to code the neighbor blocks. Video encoder 200 and video decoder 300 may apply sort or reorder entries in the intra mode list. In one example, video encoder 200 and video decoder 300 may order the entries based on a cost measure, which indicates an entry efficiency. Such a cost measure can be any cost function, such as SATD, mean squared error (MSE), or SAD cost derived from predicted and reconstructed neighbor samples for a given entry in the intra mode list.

In the case that the reconstructed neighbor samples are already derived, video encoder 200 and video decoder 300 may use different entries to derive an intra-prediction for the same neighbor samples. Video encoder 200 and video decoder 300 may then apply the cost function to the difference between predicted and reconstructed neighbor samples. Those neighbor samples may be the left or above samples of a block. In another example, the neighbor samples may include left, above, above right, above left, and below left neighbor samples. More generally, the neighbor template may include those samples and may include more than 1 line or column of such samples.

In one example, the intra mode list may only include a subset of intra modes, optionally after ordering is applied. For example, the total list size may include N modes, and, after ordering, only the first M modes are kept in the list, where M<N. Video encoder 200 and video decoder 300 may signal an entry index of the reduced mode list in the bitstream to indicate an entry used to code an intra coded block. In one example, the entries may be composed of the intra MPM modes and other intra-prediction methods that video encoder 200 and video decoder 300 can enable or disable for an entry.

In another example, video encoder 200 and video decoder 300 may always enable or disable certain intra methods for all entries or a subset of entries of the intra mode list. For example, video encoder 200 and video decoder 300 may apply the intra-prediction fusion to all modes in the candidate list. In another example, video encoder 200 and video decoder 300 may construct the candidate list first with intra-prediction fusion disabled.

In some examples, video encoder 200 and video decoder 300 may use a subset of all possible components without always applying intra-prediction fusion. Video encoder 200 and video decoder 300 may order and prune entries based on an entry cost function, to reduce the list to a desirable size. Video encoder 200 and video decoder 300 may add the entries to a list including the initial entries where intra-prediction fusion is enabled. In one example, the size of candidate list with remaining modes may double by adding the pruned modes with intra-prediction fusion. Then, video encoder 200 and video decoder 300 may apply a second round of pruning with cost on the candidate list to pick the first P modes, for example, P=10, with the least cost in the candidate list. Video encoder 200 and video decoder 300 may signal the index of the chosen mode in the bitstream.

The pruning based on the cost can be an operation indicating which intra modes can be removed from the list. In one example, if two costs are closed, e.g., the absolute difference is less than a threshold, such entries may be considered equivalent, and video encoder 200 and video decoder 300 may remove one entry from the list, for example, the entry that has a larger index.

In another example, video encoder 200 and video decoder 300 may construct a separate MPM list or a secondary MPM list, which may be a subgroup of a larger MPM list related to an intra fusion mode based on modes from the neighbor CUs and intra modes of the adjacent blocks. Video encoder 200 and video decoder 300 may enable intra-prediction fusion for all modes in such fusion MPM list or subgroup.

In some examples, video encoder 200 and video decoder 300 may choose the other reference lines as the lines not applied in any MRL prediction. For example, when line3 is the current reference line and line4 is the other reference line, video encoder 200 and video decoder 300 may not use line 4 in MRL, which may provide intra-prediction diversity. In another example, video encoder 200 and video decoder 300 may choose the reference line that has a distance l to the current reference line as the other reference line. For example, l=1 may indicate the other reference line is the above adjacent reference line. In another example, l=−1 may indicate the other reference line is the below adjacent reference line.

In one example, video encoder 200 and video decoder 300 may check a CTU boundary before implementing the disclosed intra-prediction fusion method. If the other reference lines are located outside the CTU boundary and optionally are also outside of the existing line buffer (e.g., the reference lines stored for already existing intra-prediction methods), video encoder 200 and video decoder 300 may disable the disclosed fusion mode techniques. In another example, video encoder 200 and video decoder 300 may always enable fusion regardless of the CTU boundary configuration.

Video encoder 200 and video decoder 300 may filter the fusion of predictors with a two-dimensional (2D) filter, such as a low pass filter, a high pass filter, etc., to generate one or more prediction samples. For example, video encoder 200 and video decoder 300 may use multiple reference lines an input to a 2D filter to generate prediction sample. In one example, the 2D filter may represent the interpolation or smoothing applied to the reference samples and the disclosed intra-prediction fusion to generate the intra predictor. For example, the 2D filter can be 2 by 3 low pass filter. In another example, the 2D filter can be 3 by 3 high pass filter. Video encoder 200 and video decoder 300 may code the block of video data using the one or more prediction samples.

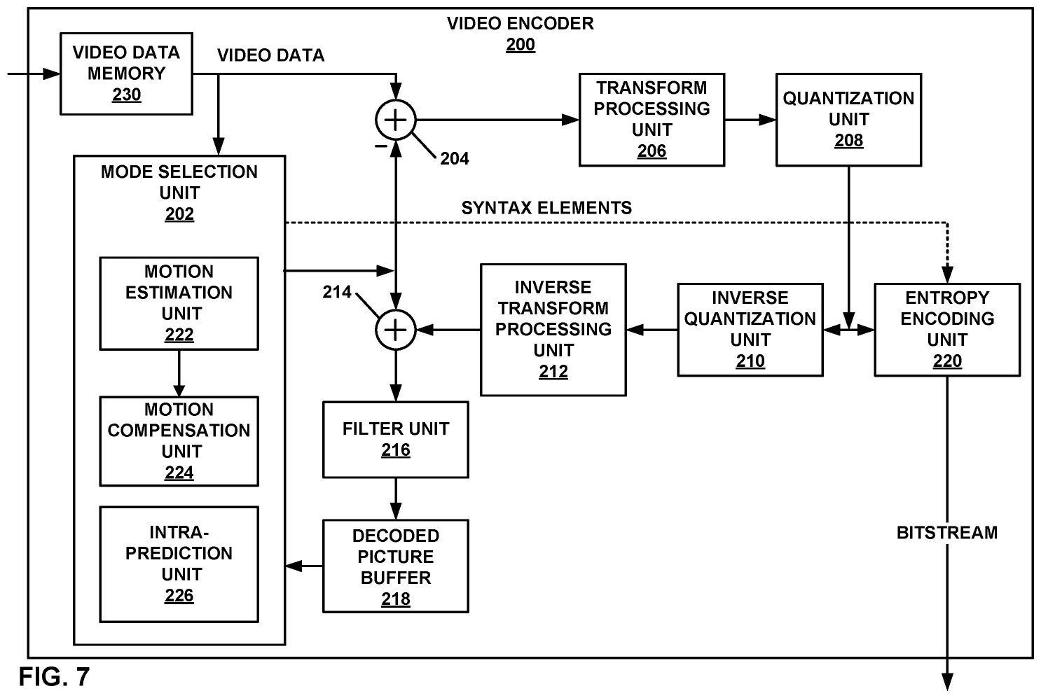

FIG. 7 is a block diagram illustrating an example video encoder 200 that may perform the techniques of this disclosure. FIG. 7 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards and video coding formats, such as AV1 and successors to the AV1 video coding format.

In the example of FIG. 7, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 7 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a CU 130, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra-prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra-prediction, non-directional intra-prediction, recursive filter intra-prediction, chroma-from-luma (CFL) prediction, intra block copy (IBC), and/or color palette mode. Mode selection unit 202 may include additional functional units to perform video prediction in accordance with other prediction modes.

Intra-prediction unit 226 may generate a fusion of predictors from two or more reference lines of samples relative to a block of video data based on an intra-prediction mode, as described herein. In some examples, intra-prediction unit 226 may generate the fusion of predictors based on a weighted combination of the predictors from the two or more reference lines of samples based on the intra-prediction mode. In some examples, intra-prediction unit 226 may select the reference lines for the predictors as combinations of any two intra predictors, for example derived from any two reference lines.

In some examples, intra-prediction unit 226 may generate the fusion of predictors based on a weighted combination of the predictors from two or more intra modes derived from the same reference line, but using different intra-prediction methods. Intra-prediction unit 226 may be configured to generate a fusion of predictors from two or more reference lines of samples relative to a block of video data, and encode the block of video data using the fusion of predictors and the intra-prediction mode. In some examples, intra-prediction unit 226 may only apply intra-prediction fusion for the modes that have non-integer slopes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of CU 130 and the size of a PU may refer to the size of a luma prediction unit of the PU. Assuming that the size of a particular CU is 2N×2N, video encoder 200 may support PU sizes of 2N×2N or N×N for intra-prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to generate a fusion of predictors from two or more reference lines of samples relative to a block of video data, and encode the block of video data using the fusion of predictors.

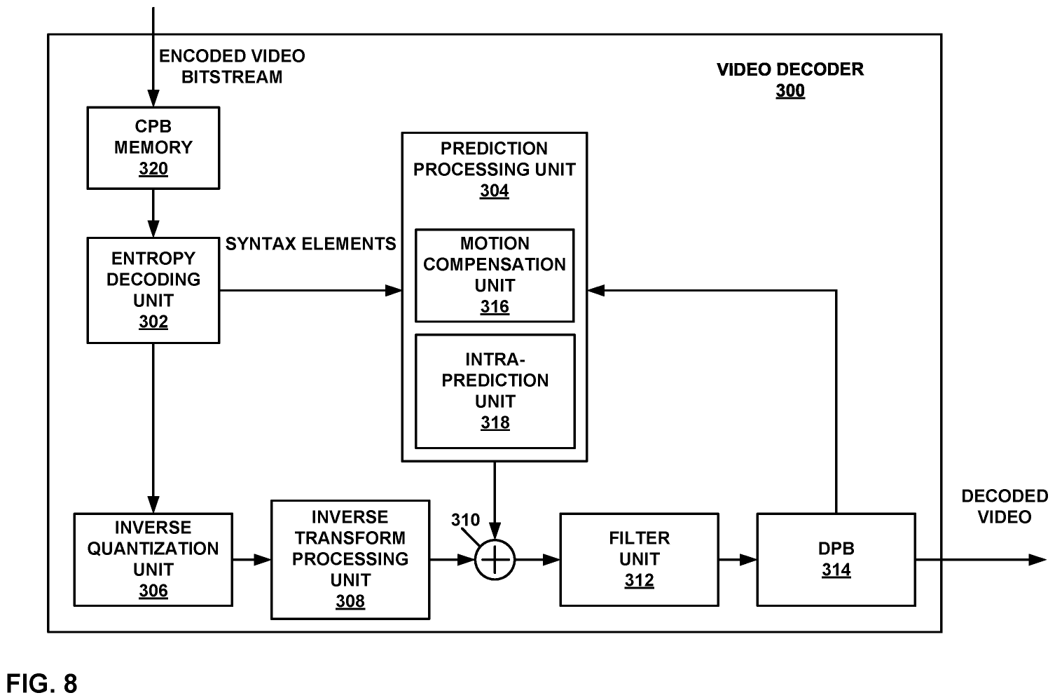

FIG. 8 is a block diagram illustrating an example video decoder 300 that may perform the techniques of this disclosure. FIG. 8 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 8, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, compensation unit 316 may be configured to decode coding blocks of video data (e.g., both luma and chroma coding blocks) using translational motion compensation, affine motion compensation, OBMC, and/or compound inter-intra-prediction, as described above. Intra-prediction unit 318 may be configured to decode coding blocks of video data (e.g., both luma and chroma coding blocks) using directional intra-prediction, non-directional intra-prediction, recursive filter intra-prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 8 are illustrated to assist with understanding the operations performed by video decoder 300. The units may be implemented as fixed-function circuits, programmable circuits, or a combination thereof. Similar to FIG. 7, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 7).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 7). Intra-prediction unit 318 may retrieve data of neighboring samples to the current block from DPB 314.

Intra-prediction unit 318 may generate a fusion of predictors from two or more reference lines of samples relative to a block of video data based on an intra-prediction mode, as described herein. In some examples, intra-prediction unit 318 may generate the fusion of predictors based on a weighted combination of the predictors from the two or more reference lines of samples based on the intra-prediction mode. In some examples, intra-prediction unit 318 may select the reference lines for the predictors as combinations of any two intra predictors, for example derived from any two reference lines.

In some examples, intra-prediction unit 318 may generate the fusion of predictors based on a weighted combination of the predictors from two or more intra modes derived from the same reference line, but using different intra-prediction methods. Intra-prediction unit 318 may be configured to generate a fusion of predictors from two or more reference lines of samples relative to a block of video data, and decode the block of video data using the fusion of predictors and the intra-prediction mode. In some examples, intra-prediction unit 318 may only apply intra-prediction fusion for the modes that have non-integer slopes.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured generate a fusion of predictors from two or more reference lines of samples relative to a block of video data, and decode the block of video data using the fusion of predictors.

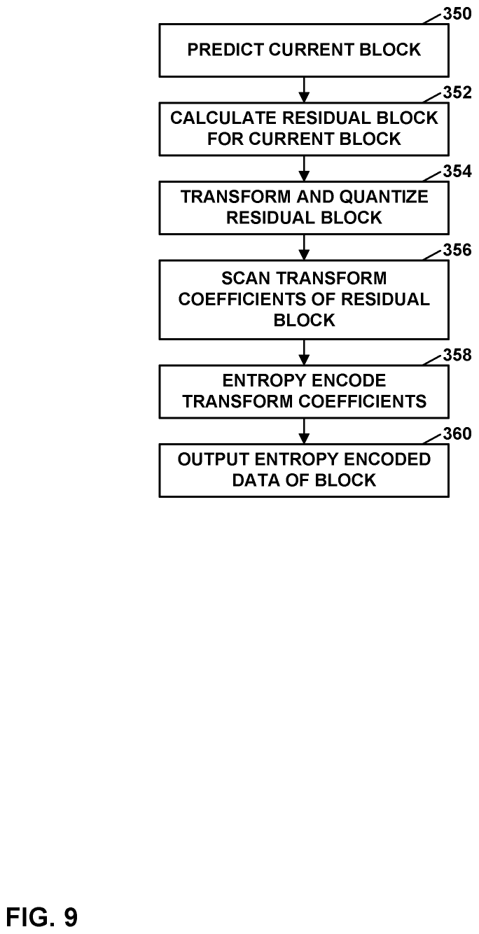

FIG. 9 is a flowchart illustrating an example method for encoding a current block in accordance with the techniques of this disclosure. The current block may comprise a CU 130. Although described with respect to video encoder 200 (FIGS. 1 and 7), it should be understood that other devices may be configured to perform a method similar to that of FIG. 9.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

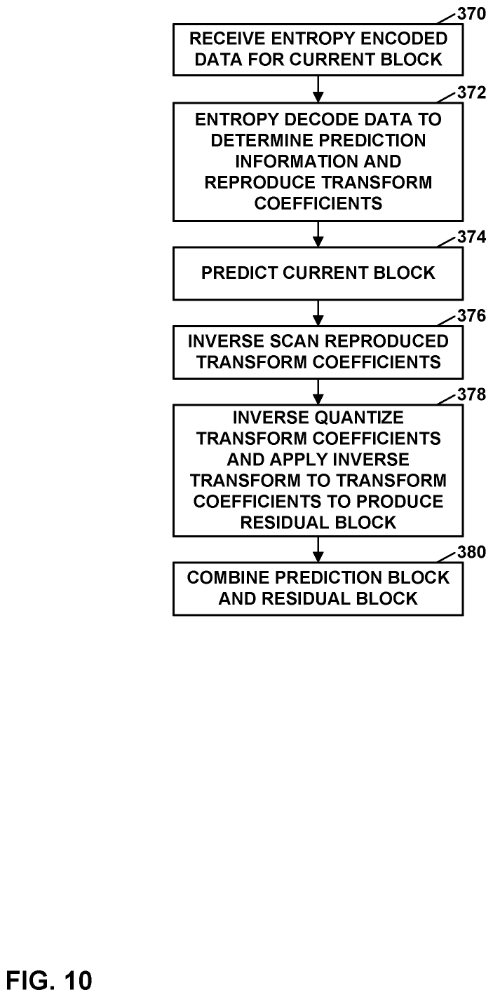

FIG. 10 is a flowchart illustrating an example method for decoding a current block of video data in accordance with the techniques of this disclosure. The current block may comprise a CU 130. Although described with respect to video decoder 300 (FIGS. 1 and 8), it should be understood that other devices may be configured to perform a method similar to that of FIG. 10.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

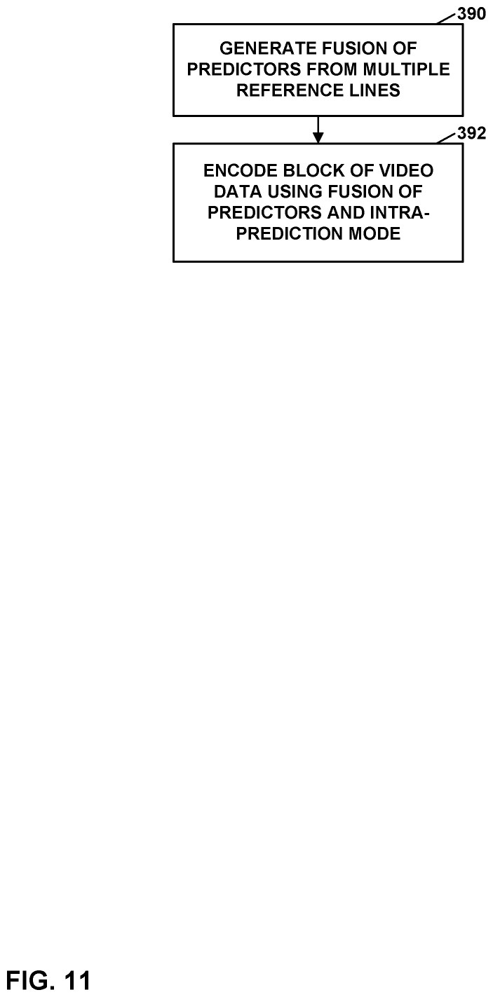

FIG. 11 is a flowchart illustrating an example method for encoding a current block in accordance with the techniques of this disclosure. The current block may comprise a CU 130. Although described with respect to video encoder 200 (FIGS. 1 and 7), it should be understood that other devices may be configured to perform a method similar to that of FIG. 11.

In this example, video encoder 200 may generate a fusion of predictors from two or more reference lines of samples relative to a block of video data based on an intra-prediction mode (390). In some examples, video encoder 200 may generate the fusion of predictors based on a weighted combination of the predictors from two or more reference lines of samples based on the intra-prediction mode. For example, video encoder 200 may select the reference lines for the predictors as combinations of a regular default reference line (e.g., line0) and other, different reference lines.

In some examples, video encoder 200 may determine the predictors from the two or more reference lines of samples using the same intra-prediction mode. In another example, video encoder 200 may determine the predictors from the two or more reference lines of samples using at least two different intra-prediction modes. Video encoder 200 may apply the intra-prediction fusion to an intra-prediction mode that has a non-integer slope.

Video encoder 200 may choose the reference lines as subsets of the lines used in MRL prediction. In some examples, the subset of the set of reference lines of samples includes a default reference line of samples adjacent the block of video data, and another reference line of samples adjacent the default reference line of samples. In some examples, video encoder 200 may choose the other reference lines as the reference lines that have certain distance to the regular default reference line. In some examples, video encoder 200 may choose the other reference lines specifically as lines not used in MRL prediction to provide diversity. For example, the other reference lines may be line2 and line4, which are not used in the current MRL mode. In another example, the other reference lines may also be a mix of reference lines that are used and not used in MRL.

In one example, video encoder 200 may achieve a fusion of two or more intra predictors by determining a weighted combination of the predictors from multiple reference lines. For example, video encoder 200 may apply a first weight to predictors in a default reference line, and apply a second weight to predictors in the other reference line. In one example, the weights for each predictors may be fixed. For example, video encoder 200 may determine that the first weight is 0.75 and the second weight is 0.25. In another example, video encoder 200 may determine the weights based on the position of a current sample in the block and one or more of a width or a height of the block. In yet another example, video encoder 200 may determine the weights based on certain criteria, such as whether the absolute value of first predictors minus second predictors satisfies a threshold (e.g., being greater than or equal to the threshold).

Video encoder 200 may apply one or more interpolation filters to the block of video data. Video encoder 200 may derive the prediction samples from the reference sample after interpolation with any types of filters, for example, 6-tap filter or 4-tap filter. In some examples, video encoder 200 may derive the prediction samples from a mix of different types of filters. For example, video encoder 200 may derive one prediction sample from 6-tap interpolation filter and another prediction sample from 4-tap interpolation filter.

Video encoder 200 may filter the fusion of predictors with a two-dimensional (2D) filter, such as a low pass filter, a high pass filter, etc., to generate one or more prediction samples. For example, video encoder 200 may use multiple reference lines an input to a 2D filter to generate prediction sample. In one example, the 2D filter may represent the interpolation or smoothing applied to the reference samples and the disclosed intra-prediction fusion to generate the intra predictor. For example, the 2D filter can be 2 by 3 low pass filter. In another example, the 2D filter can be 3 by 3 high pass filter. Video encoder 200 may code the block of video data using the one or more prediction samples.

In any case, video encoder 300 may encode the block of video data using the fusion of predictors and the intra-prediction mode (392). In this way, the techniques may improve intra-prediction and in turn improve compression efficiency, visual quality, and more.

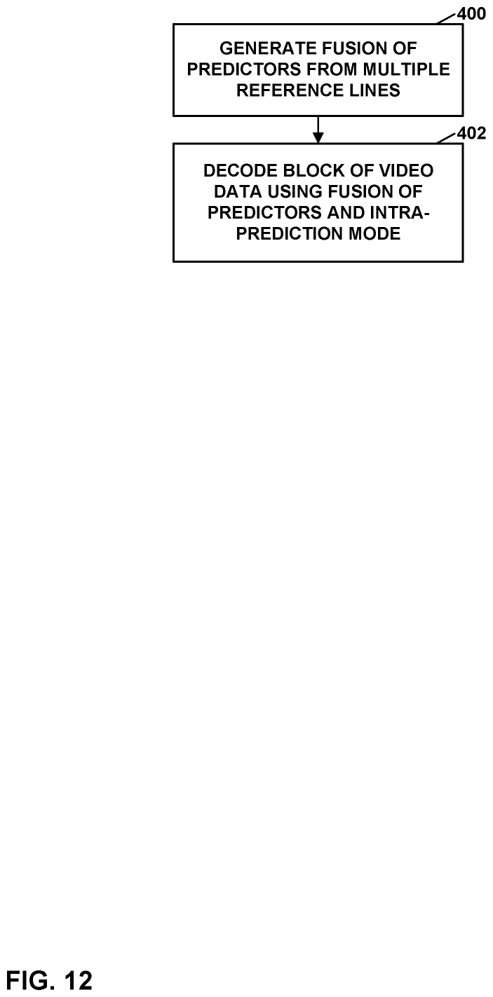

FIG. 12 is a flowchart illustrating an example method for decoding a current block of video data in accordance with the techniques of this disclosure. The current block may comprise a CU 130. Although described with respect to video decoder 300 (FIGS. 1 and 8), it should be understood that other devices may be configured to perform a method similar to that of FIG. 12.

In this example, video decoder 300 may generate a fusion of predictors from two or more reference lines of samples relative to a block of video data based on an intra-prediction mode (400). In some examples, video decoder 300 may generate the fusion of predictors based on a weighted combination of the predictors from two or more reference lines of samples based on the intra-prediction mode. For example, video decoder 300 may select the reference lines for the predictors as combinations of a regular default reference line (e.g., line0) and other, different reference lines.

In some examples, video decoder 300 may determine the predictors from the two or more reference lines of samples using the same intra-prediction mode. In another example, video decoder 300 may determine the predictors from the two or more reference lines of samples using at least two different intra-prediction modes. Video decoder 300 may apply the intra-prediction fusion to an intra-prediction mode that has a non-integer slope.

Video decoder 300 may choose the reference lines as subsets of the lines used in MRL prediction. In some examples, the subset of the set of reference lines of samples includes a default reference line of samples adjacent the block of video data, and another reference line of samples adjacent the default reference line of samples. In some examples, video decoder 300 may choose the other reference lines as the reference lines that have certain distance to the regular default reference line. In some examples, video decoder 300 may choose the other reference lines specifically as lines not used in MRL prediction to provide diversity. For example, the other reference lines may be line2 and line4, which are not used in the current MRL mode. In another example, the other reference lines may also be a mix of reference lines that are used and not used in MRL.

In one example, video decoder 300 may achieve a fusion of two or more intra predictors by determining a weighted combination of the predictors from multiple reference lines. For example, video decoder 300 may apply a first weight to predictors in a default reference line, and apply a second weight to predictors in the other reference line. In one example, the weights for each predictors may be fixed. For example, video decoder 300 may determine that the first weight is 0.75 and the second weight is 0.25. In another example, video decoder 300 may determine the weights based on the position of a current sample in the block and one or more of a width or a height of the block. In yet another example, video decoder 300 may determine the weights based on certain criteria, such as whether the absolute value of first predictors minus second predictors satisfies a threshold.

Video decoder 300 may apply one or more interpolation filters to the block of video data. Video decoder 300 may derive the prediction samples from the reference sample after interpolation with any types of filters, for example, 6-tap filter or 4-tap filter. In some examples, video decoder 300 may derive the prediction samples from a mix of different types of filters. For example, video decoder 300 may derive one prediction sample from 6-tap interpolation filter and another prediction sample from 4-tap interpolation filter.

Video decoder 300 may filter the fusion of predictors with a two-dimensional (2D) filter, such as a low pass filter, a high pass filter, etc., to generate one or more prediction samples. For example, video decoder 300 may use multiple reference lines an input to a 2D filter to generate prediction sample. In one example, the 2D filter may represent the interpolation or smoothing applied to the reference samples and the disclosed intra-prediction fusion to generate the intra predictor. For example, the 2D filter can be 2 by 3 low pass filter. In another example, the 2D filter can be 3 by 3 high pass filter. Video decoder 300 may code the block of video data using the one or more prediction samples.

In any case, video encoder 300 may encode the block of video data using the fusion of predictors and the intra-prediction mode (402). In this way, the techniques may improve intra-prediction and in turn improve compression efficiency, visual quality, and more.

Other illustrative aspects of the disclosure are described below.

Aspect 1A—A method of coding video data, the method comprising: generating a fusion of predictors from two or more reference lines of samples relative to a block of video data; and coding the block of video data using the fusion of predictors.

Aspect 2A—The method of Aspect 1A, wherein the two or more reference lines of samples includes a default reference line of samples.

Aspect 3A—The method of Aspect 2A, wherein the default reference line of samples is immediately adjacent the block of video data.

Aspect 4A—The method of Aspect 1A, further comprising: determining the predictors from the two or more reference lines of samples using the same intra-prediction mode.

Aspect 5A—The method of Aspect 1A, further comprising: determining the predictors from the two or more reference lines of samples using at least two different intra-prediction modes.

Aspect 6A—The method of Aspect 1A, wherein the two or more reference lines of samples are a subset of a set of reference lines of samples for a multiple reference line coding mode.

Aspect 7A—The method of Aspect 6A, wherein the set of reference lines of samples for the multiple reference line coding mode include line 0, line 1, line 3, line 5, line 7, and line 12 relative to the block of video data.

Aspect 8A—The method of Aspect 7A, wherein the subset of the set of reference lines of samples include line 0 and line 1.

Aspect 9A—The method of Aspect 7A, wherein the subset of the set of reference lines of samples include line 0, line 3, and line 5.

Aspect 10A—The method of Aspect 7A, wherein the subset of the set of reference lines of samples include line 3 and line 5.

Aspect 11A—The method of Aspect 1A, further comprising: determining at least one of the two or more reference lines of samples based on a distance in samples for a default reference line of samples.

Aspect 12A—The method of Aspect 1A, wherein at least one of the two or more reference lines of samples are not in a set of reference lines of samples for a multiple reference line coding mode.

Aspect 13A—The method of Aspect 1A, wherein generating the fusion of predictors from two or more reference lines of samples relative to a block of video data comprises: generating the fusion of predictors based on a weighted combination of predictors from the two or more reference lines of samples.

Aspect 14A—The method of Aspect 13A, wherein a weight for the weighted combination is fixed.

Aspect 15A—The method of Aspect 13A, wherein a weight for the weighted combination is based on a reference line.

Aspect 16A—The method of Aspect 13A, wherein a weight for the weighted combination is based on a position of a sample in the block of video data.

Aspect 17A—The method of Aspect 13A, wherein a weight for the weighted combination is based on distance between two reference lines of the two or more reference lines of samples.

Aspect 18A—The method of Aspect 13A, wherein a weight for the weighted combination is based on a cost criterion.

Aspect 19A—The method of Aspect 1A, wherein generating the fusion of predictors from two or more reference lines of samples relative to a block of video data comprises: generating the fusion of predictors based on a weighted gradient of predictors from the two or more reference lines of samples.

Aspect 20A—The method of Aspect 1A, further comprising: determining to generate the fusion of predictors based on one or more of an intra-prediction mode or a syntax element received in an encoded video bitstream.

Aspect 21A—The method of Aspect 1A, further comprising: performing, in addition to generating the fusion of predictors, one or more of a template-based intra mode derivation mode or decoder-side intra mode derivation mode.

Aspect 22A—The method of any of Aspects 1A-21A, wherein coding comprises decoding.

Aspect 23A—The method of any of Aspects 1A-21A, wherein coding comprises encoding.

Aspect 24A—A device for coding video data, the device comprising one or more means for performing the method of any of Aspects 1A-23A.

Aspect 25A—The device of Aspect 24A, wherein the one or more means comprise one or more processors implemented in circuitry.

Aspect 26A—The device of any of Aspects 24A and 25A, further comprising a memory to store the video data.

Aspect 27A—The device of any of Aspects 24A-26A, further comprising a display configured to display decoded video data.

Aspect 28A—The device of any of Aspects 24A-27A, wherein the device comprises one or more of a camera, a computer, a mobile device, a broadcast receiver device, or a set-top box.

Aspect 29A—The device of any of Aspects 24A-28A, wherein the device comprises a video decoder.

Aspect 30A—The device of any of Aspects 24A-29A, wherein the device comprises a video encoder.

Aspect 31A—A computer-readable storage medium having stored thereon instructions that, when executed, cause one or more processors to perform the method of any of Aspects 1A-23A.

Aspect 1B: A method of decoding video data includes generating a fusion of predictors from two or more reference lines of samples relative to a block of video data based on an intra-prediction mode; and decoding the block of video data using the fusion of predictors and the intra-prediction mode.

Aspect 2B: The method of aspect 1B, wherein the intra-prediction mode has a non-integer slope.

Aspect 3B: The method of any of aspects 1B and 2B, wherein generating the fusion of the predictors from the two or more reference lines of samples relative to the block of video data based on the intra-prediction mode comprises: generating the fusion of predictors based on a weighted combination of the predictors from the two or more reference lines of samples based on the intra-prediction mode.

Aspect 4B: The method of aspect 3B, wherein generating the fusion of predictors based on the weighted combination of the predictors from the two or more reference lines of samples based on the intra-prediction mode comprises: applying a first weight to first predictors in a first reference line of the two or more reference lines of samples; and applying a second weight to second predictors in a second reference line of the two or more reference lines of samples, wherein the first reference line is closer to the block of video data than the second reference line.

Aspect 5B: The method of aspect 4B, wherein the first weight is 0.75 and the second weight is 0.25.

Aspect 6B: The method of any of aspects 4B and 5B, wherein the method further includes determining that the first weight is 0.75 and the second weight is 0.25 in response to an absolute value of the first predictors minus the second predictors being greater than or equal to a threshold; and determining that the first weight is 0.5 and the second weight is 0.5 in response to the absolute value of the first predictors minus the second predictors being less than the threshold.

Aspect 7B: The method of any of aspects 4B through 6B, wherein the method further includes determining the first weight based on a position of a sample in the block and one or more of a width or a height of the block; and determining the second weight is based on the position of the sample and one or more of the width or the height of the block.

Aspect 8B: The method of any of aspects 1B through 7B, wherein generating the fusion of predictors comprises: filtering the two or more reference lines of samples using one of a low pass filter or a high pass filter to generate one or more prediction samples, and wherein decoding the block of video data comprises decoding the block of video data using the one or more prediction samples.

Aspect 9B: The method of any of aspects 1B through 8B, wherein generating the fusion of predictors is in response to an intra sub partition mode being disabled.

Aspect 10B: The method of any of aspects 1B through 9B, wherein the method further includes determining the predictors from the two or more reference lines of samples using at least two different intra-prediction modes, wherein the at least two different intra-prediction modes are angular modes.

Aspect 11B: The method of any of aspects 1B through 10B, wherein the two or more reference lines of samples includes a first reference line from a set of reference lines of samples for a multiple reference line coding mode.

Aspect 12B: The method of aspect 11B, wherein the two or more reference lines of samples further includes a second reference line of samples adjacent and above the first reference line of samples.

Aspect 13B: An apparatus configured to decode video data includes a memory configured to store a block of video data; and one or more processors implemented in circuitry and in communication with the memory, the one or more processors configured to: generate a fusion of predictors from two or more reference lines of samples relative to a block of video data based on an intra-prediction mode; and decode the block of video data using the fusion of predictors and the intra-prediction mode.

Aspect 14B: The apparatus of aspect 13B, wherein the intra-prediction mode has a non-integer slope.

Aspect 15B: The apparatus of any of aspects 13B and 14B, wherein to generate the fusion of the predictors from the two or more reference lines of samples relative to the block of video data based on the intra-prediction mode, the one or more processors are further configured to: generate the fusion of predictors based on a weighted combination of the predictors from the two or more reference lines of samples based on the intra-prediction mode.

Aspect 16B: The apparatus of aspect 15B, wherein to generate the fusion of predictors based on the weighted combination of the predictors from the two or more reference lines of samples based on the intra-prediction mode, the one or more processors are further configured to: applying a first weight to first predictors in a first reference line of the two or more reference lines of samples; and applying a second weight to second predictors in a second reference line of the two or more reference lines of samples, wherein the first reference line is closer to the block of video data than the second reference line.

Aspect 17B: The apparatus of aspect 16B, wherein the first weight is 0.75 and the second weight is 0.25.

Aspect 18B: The apparatus of any of aspects 16B and 17B, wherein the one or more processors are further configured to: determine that the first weight is 0.75 and the second weight is 0.25 in response to an absolute value of the first predictors minus the second predictors being greater than or equal to a threshold; and determine that the first weight is 0.5 and the second weight is 0.5 in response to the absolute value of the first predictors minus the second predictors being less than the threshold.

Aspect 19B: The apparatus of any of aspects 16B through 18B, wherein the one or more processors are further configured to: determine the first weight based on a position of a sample in the block and one or more of a width or a height of the block; and determine the second weight is based on the position of the sample and one or more of the width or the height of the block.

Aspect 20B: The apparatus of any of aspects 13B through 19B, wherein, to generate the fusion of predictors, the one or more processors are further configured to: filter the two or more reference lines using one of a low pass filter or a high pass filter to generate one or more prediction samples, and wherein, to decode the block of video data, the one or more processors are further configured to decode the block of video data using the one or more prediction samples.

Aspect 21B: The apparatus of any of aspects 13B through 20B, wherein the one or more processors are configured to: generate the fusion of predictors in response to an intra sub partition mode being disabled.

Aspect 22B: The apparatus of any of aspects 13B through 21B, wherein the one or more processors are further configured to: determining the predictors from the two or more reference lines of samples using at least two different intra-prediction modes, wherein the at least two different intra-prediction modes are angular modes.

Aspect 23B: The apparatus of any of aspects 13B through 22B, wherein the two or more reference lines of samples includes a first reference line from a set of reference lines of samples for a multiple reference line coding mode.

Aspect 24B: The apparatus of aspect 23B, wherein the two or more reference lines of samples further includes a second reference line of samples adjacent and above the first reference line of samples.

Aspect 25B: A method of encoding video data includes generating a fusion of predictors from two or more reference lines of samples relative to a block of video data based on an intra-prediction mode; and encoding the block of video data using the fusion of predictors and the intra-prediction mode.

Aspect 26B: The method of aspect 25B, wherein the intra-prediction mode has a non-integer slope.

Aspect 27B: The method of any of aspects 25B and 26B, wherein generating the fusion of the predictors from the two or more reference lines of samples relative to the block of video data based on the intra-prediction mode comprises: generating the fusion of predictors based on a weighted combination of the predictors from the two or more reference lines of samples based on the intra-prediction mode.

Aspect 28B: The method of aspect 27B, wherein generating the fusion of predictors based on the weighted combination of the predictors from the two or more reference lines of samples based on the intra-prediction mode comprises: applying a first weight to first predictors in a first reference line of the two or more reference lines of samples; and applying a second weight to second predictors in a second reference line of the two or more reference lines of samples, wherein the first reference line is closer to the block of video data than the second reference line.

Aspect 29B: The method of aspect 28B, wherein the first weight is 0.75 and the second weight is 0.25.

Aspect 30B: The method of any of aspects 28B and 29B, wherein the method further includes determining that the first weight is 0.75 and the second weight is 0.25 in response to an absolute value of the first predictors minus the second predictors being greater than or equal to a threshold; and determining that the first weight is 0.5 and the second weight is 0.5 in response to the absolute value of the first predictors minus the second predictors being less than the threshold.

Aspect 31B: The method of any of aspects 28B through 30B, wherein the method further includes determining the first weight based on a position in the block and one or more of a width or a height of the block; and determining the second weight is based on the position of the sample and one or more of the width or the height of the block.

Aspect 32B: The method of any of aspects 25B through 31B, wherein generating the fusion of predictors comprises: filtering the two or more reference lines using one of a low pass filter or a high pass filter to generate one or more prediction samples, and wherein encoding the block of video data comprises encoding the block of video data using the one or more prediction samples.

Aspect 33B: The method of any of aspects 25B through 32B, wherein generating the fusion of predictors is in response to an intra sub partition mode being disabled.

Aspect 34B: The method of any of aspects 25B through 33, wherein the method further includes determining the predictors from the two or more reference lines of samples using at least two different intra-prediction modes, wherein the at least two different intra-prediction modes are angular modes.

Aspect 35B: The method of any of aspects 25B through 34B, wherein the two or more reference lines of samples includes a first reference line from a set of reference lines of samples for a multiple reference line coding mode.

Aspect 36B: The method of aspect 35B, wherein the two or more reference lines of samples further includes a second reference line of samples adjacent and above the first reference line of samples.

Aspect 37B: An apparatus configured to encode video data includes a memory configured to store a block of video data; and one or more processors implemented in circuitry and in communication with the memory, the one or more processors configured to: generate a fusion of predictors from two or more reference lines of samples relative to a block of video data based on an intra-prediction mode; and encode the block of video data using the fusion of predictors and the intra-prediction mode.

Aspect 38B: The apparatus of aspect 37B, wherein the intra-prediction mode has a non-integer slope.

Aspect 39B: The apparatus of any of aspects 37B and 38B, wherein to generate the fusion of the predictors from the two or more reference lines of samples relative to the block of video data based on the intra-prediction mode, the one or more processors are further configured to: generate the fusion of predictors based on a weighted combination of the predictors from the two or more reference lines of samples based on the intra-prediction mode.

Aspect 40B: The apparatus of aspect 39B, wherein to generate the fusion of predictors based on the weighted combination of the predictors from the two or more reference lines of samples based on the intra-prediction mode, the one or more processors are further configured to: applying a first weight to first predictors in a first reference line of the two or more reference lines of samples; and applying a second weight to second predictors in a second reference line of the two or more reference lines of samples, wherein the first reference line is closer to the block of video data than the second reference line.

Aspect 41B: The apparatus of aspect 40B, wherein the first weight is 0.75 and the second weight is 0.25.

Aspect 42B: The apparatus of any of aspects 40B and 41B, wherein the one or more processors are further configured to: determine that the first weight is 0.75 and the second weight is 0.25 in response to an absolute value of the first predictors minus the second predictors being greater than or equal to a threshold; and determine that the first weight is 0.5 and the second weight is 0.5 in response to the absolute value of the first predictors minus the second predictors being less than the threshold.

Aspect 43B: The apparatus of any of aspects 40B through 42B, wherein the one or more processors are further configured to: determine the first weight based on a position in the block and one or more of a width or a height of the block; and determine the second weight is based on the position of the sample and one or more of the width or the height of the block.

Aspect 44B: The apparatus of any of aspects 37B through 43B, wherein, to generate the fusion of predictors, the one or more processors are further configured to: filter the two or more reference lines using one of a low pass filter or a high pass filter to generate one or more prediction samples, and wherein, to decode the block of video data, the one or more processors are further configured to decode the block of video data using the one or more prediction samples.

Aspect 45B: The apparatus of any of aspects 37B through 44BB, wherein the one or more processors are configured to: generate the fusion of predictors in response to an intra sub partition mode being disabled.

Aspect 46B: The apparatus of any of aspects 37B through 45B, wherein the one or more processors are further configured to: determining the predictors from the two or more reference lines of samples using at least two different intra-prediction modes, wherein the at least two different intra-prediction modes are angular modes.

Aspect 47B: The apparatus of any of aspects 37B through 46B, wherein the two or more reference lines of samples includes a first reference line from a set of reference lines of samples for a multiple reference line coding mode.

Aspect 48B: The apparatus of aspect 47B, wherein the two or more reference lines of samples further includes a second reference line of samples adjacent and above the first reference line of samples.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
generating a fusion of predictors from two or more reference lines of samples relative to a block of video data based on an intra-prediction mode; and
decoding the block of video data using the fusion of predictors and the intra-prediction mode.

2. The method of claim 1, wherein the intra-prediction mode has a non-integer slope.

3. The method of claim 1, wherein generating the fusion of the predictors from the two or more reference lines of samples relative to the block of video data based on the intra-prediction mode comprises:
generating the fusion of predictors based on a weighted combination of the predictors from the two or more reference lines of samples based on the intra-prediction mode.

4. The method of claim 3, wherein generating the fusion of predictors based on the weighted combination of the predictors from the two or more reference lines of samples based on the intra-prediction mode comprises:
applying a first weight to first predictors in a first reference line of the two or more reference lines of samples; and
applying a second weight to second predictors in a second reference line of the two or more reference lines of samples, wherein the first reference line is closer to the block of video data than the second reference line.

5. The method of claim 4, wherein the first weight is 0.75 and the second weight is 0.25.

6. The method of claim 4, further comprising:
determining that the first weight is 0.75 and the second weight is 0.25 in response to an absolute value of the first predictors minus the second predictors being greater than or equal to a threshold; and
determining that the first weight is 0.5 and the second weight is 0.5 in response to the absolute value of the first predictors minus the second predictors being less than the threshold.

7. The method of claim 4, further comprising:
determining the first weight based on a position of a sample in the block and one or more of a width or a height of the block; and
determining the second weight is based on the position of the sample and one or more of the width or the height of the block.

8. The method of claim 1, wherein generating the fusion of predictors comprises:
filtering the two or more reference lines of samples using one of a low pass filter or a high pass filter to generate one or more prediction samples, and
wherein decoding the block of video data comprises decoding the block of video data using the one or more prediction samples.

9. The method of claim 1, wherein generating the fusion of predictors is in response to an intra sub partition mode being disabled.

10. The method of claim 1, further comprising:
determining the predictors from the two or more reference lines of samples using at least two different intra-prediction modes, wherein the at least two different intra-prediction modes are angular modes.

11. The method of claim 1, wherein the two or more reference lines of samples includes a first reference line from a set of reference lines of samples for a multiple reference line coding mode.

12. The method of claim 11, wherein the two or more reference lines of samples further includes a second reference line of samples adjacent and above the first reference line of samples.

13. An apparatus configured to decode video data, the apparatus comprising:
a memory configured to store a block of video data; and
one or more processors implemented in circuitry and in communication with the memory, the one or more processors configured to:
generate a fusion of predictors from two or more reference lines of samples relative to a block of video data based on an intra-prediction mode; and
decode the block of video data using the fusion of predictors and the intra-prediction mode.

14. The apparatus of claim 13, wherein the intra-prediction mode has a non-integer slope.

15. The apparatus of claim 13, wherein to generate the fusion of the predictors from the two or more reference lines of samples relative to the block of video data based on the intra-prediction mode, the one or more processors are further configured to:
generate the fusion of predictors based on a weighted combination of the predictors from the two or more reference lines of samples based on the intra-prediction mode.

16. The apparatus of claim 15, wherein to generate the fusion of predictors based on the weighted combination of the predictors from the two or more reference lines of samples based on the intra-prediction mode, the one or more processors are further configured to:
applying a first weight to first predictors in a first reference line of the two or more reference lines of samples; and
applying a second weight to second predictors in a second reference line of the two or more reference lines of samples, wherein the first reference line is closer to the block of video data than the second reference line.

17. The apparatus of claim 16, wherein the first weight is 0.75 and the second weight is 0.25.

18. The apparatus of claim 16, wherein the one or more processors are further configured to:
determine that the first weight is 0.75 and the second weight is 0.25 in response to an absolute value of the first predictors minus the second predictors being greater than or equal to a threshold; and
determine that the first weight is 0.5 and the second weight is 0.5 in response to the absolute value of the first predictors minus the second predictors being less than the threshold.

19. The apparatus of claim 16, wherein the one or more processors are further configured to:
determine the first weight based on a position of a sample in the block and one or more of a width or a height of the block; and
determine the second weight is based on the position of the sample and one or more of the width or the height of the block.

20. The apparatus of claim 13, wherein, to generate the fusion of predictors, the one or more processors are further configured to:
filter the two or more reference lines using one of a low pass filter or a high pass filter to generate one or more prediction samples, and
wherein, to decode the block of video data, the one or more processors are further configured to decode the block of video data using the one or more prediction samples.

21. The apparatus of claim 13, wherein the one or more processors are configured to:
generate the fusion of predictors in response to an intra sub partition mode being disabled.

22. The apparatus of claim 13, wherein the one or more processors are further configured to:
determining the predictors from the two or more reference lines of samples using at least two different intra-prediction modes, wherein the at least two different intra-prediction modes are angular modes.

23. The apparatus of claim 13, wherein the two or more reference lines of samples includes a first reference line from a set of reference lines of samples for a multiple reference line coding mode.

24. The apparatus of claim 23, wherein the two or more reference lines of samples further includes a second reference line of samples adjacent and above the first reference line of samples.

25. A method of encoding video data, the method comprising:
generating a fusion of predictors from two or more reference lines of samples relative to a block of video data based on an intra-prediction mode; and
encoding the block of video data using the fusion of predictors and the intra-prediction mode.

26. The method of claim 25, wherein the intra-prediction mode has a non-integer slope.

27. The method of claim 25, wherein generating the fusion of the predictors from the two or more reference lines of samples relative to the block of video data based on the intra-prediction mode comprises:
generating the fusion of predictors based on a weighted combination of the predictors from the two or more reference lines of samples based on the intra-prediction mode.

28. The method of claim 27, wherein generating the fusion of predictors based on the weighted combination of the predictors from the two or more reference lines of samples based on the intra-prediction mode comprises:
applying a first weight to first predictors in a first reference line of the two or more reference lines of samples; and
applying a second weight to second predictors in a second reference line of the two or more reference lines of samples, wherein the first reference line is closer to the block of video data than the second reference line.

29. The method of claim 28, wherein the first weight is 0.75 and the second weight is 0.25.

30. The method of claim 28, further comprising:
determining that the first weight is 0.75 and the second weight is 0.25 in response to an absolute value of the first predictors minus the second predictors being greater than or equal to a threshold; and
determining that the first weight is 0.5 and the second weight is 0.5 in response to the absolute value of the first predictors minus the second predictors being less than the threshold.

31. The method of claim 28, further comprising:
determining the first weight based on a position in the block and one or more of a width or a height of the block; and
determining the second weight is based on the position of the sample and one or more of the width or the height of the block.

32. The method of claim 25, wherein generating the fusion of predictors comprises:
filtering the two or more reference lines using one of a low pass filter or a high pass filter to generate one or more prediction samples, and
wherein encoding the block of video data comprises encoding the block of video data using the one or more prediction samples.

33. The method of claim 25, wherein generating the fusion of predictors is in response to an intra sub partition mode being disabled.

34. The method of claim 25, further comprising:
determining the predictors from the two or more reference lines of samples using at least two different intra-prediction modes, wherein the at least two different intra-prediction modes are angular modes.

35. The method of claim 25, wherein the two or more reference lines of samples includes a first reference line from a set of reference lines of samples for a multiple reference line coding mode.

36. The method of claim 35, wherein the two or more reference lines of samples further includes a second reference line of samples adjacent and above the first reference line of samples.

37. An apparatus configured to encode video data, the apparatus comprising:
a memory configured to store a block of video data; and
one or more processors implemented in circuitry and in communication with the memory, the one or more processors configured to:
generate a fusion of predictors from two or more reference lines of samples relative to a block of video data based on an intra-prediction mode; and
encode the block of video data using the fusion of predictors and the intra-prediction mode.

38. The apparatus of claim 37, wherein the intra-prediction mode has a non-integer slope.

39. The apparatus of claim 37, wherein to generate the fusion of the predictors from the two or more reference lines of samples relative to the block of video data based on the intra-prediction mode, the one or more processors are further configured to:
generate the fusion of predictors based on a weighted combination of the predictors from the two or more reference lines of samples based on the intra-prediction mode.

40. The apparatus of claim 39, wherein to generate the fusion of predictors based on the weighted combination of the predictors from the two or more reference lines of samples based on the intra-prediction mode, the one or more processors are further configured to:
applying a first weight to first predictors in a first reference line of the two or more reference lines of samples; and
applying a second weight to second predictors in a second reference line of the two or more reference lines of samples, wherein the first reference line is closer to the block of video data than the second reference line.

41. The apparatus of claim 40, wherein the first weight is 0.75 and the second weight is 0.25.

42. The apparatus of claim 40, wherein the one or more processors are further configured to:
determine that the first weight is 0.75 and the second weight is 0.25 in response to an absolute value of the first predictors minus the second predictors being greater than or equal to a threshold; and
determine that the first weight is 0.5 and the second weight is 0.5 in response to the absolute value of the first predictors minus the second predictors being less than the threshold.

43. The apparatus of claim 40, wherein the one or more processors are further configured to:
determine the first weight based on a position in the block and one or more of a width or a height of the block; and
determine the second weight is based on the position of the sample and one or more of the width or the height of the block.

44. The apparatus of claim 37, wherein, to generate the fusion of predictors, the one or more processors are further configured to:
filter the two or more reference lines using one of a low pass filter or a high pass filter to generate one or more prediction samples, and
wherein, to decode the block of video data, the one or more processors are further configured to decode the block of video data using the one or more prediction samples.

45. The apparatus of claim 37, wherein the one or more processors are configured to:
generate the fusion of predictors in response to an intra sub partition mode being disabled.

46. The apparatus of claim 37, wherein the one or more processors are further configured to:
determining the predictors from the two or more reference lines of samples using at least two different intra-prediction modes, wherein the at least two different intra-prediction modes are angular modes.

47. The apparatus of claim 37, wherein the two or more reference lines of samples includes a first reference line from a set of reference lines of samples for a multiple reference line coding mode.

48. The apparatus of claim 47, wherein the two or more reference lines of samples further includes a second reference line of samples adjacent and above the first reference line of samples.
